(19) United States
(12) Patent Application Publication
(10) Pub. No.: US 2008/0239994 A1
(43) Pub. Date: Oct. 2, 2008

(54) Multimedia Conference Resource Sharing System and Method

(76) Inventors: Hai Xiong, Plano, TX (US); Xiaogang Zhou, Plano, TX (US); Tuyet-Hoa Thi Nguyen, Allen, TX (US)

Correspondence Address: CONLEY ROSE, P.C., 5601 GRANITE PARKWAY, SUITE 750, PLANO, TX, 75024, US

(21) Appl. No.: 11/691,238

(22) Filed: Mar. 26, 2007

(51) Int. Cl. H04L 12/16

(52) U.S. Cl. 370/260

(57) ABSTRACT

A multimedia conference system is provided that includes a conference server, a file server, an organizer system, and one or more participant systems. The conference server is configured to promote participants conferencing. The file server is configured to maintain conference related multimedia content. The organizer system is used by an organizer to arrange a conference using the conference server. The organizer uses the organizer system to promote storing conference related multimedia content to the file server. The one or more participant systems are used by participants to join the conference and retrieve separate instances of the conference related multimedia content. A method for multimedia conferencing is also provided.

### CROSS-REFERENCE TO RELATED APPLICATIONS

None

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Conference calls are conducted to communicate information between a plurality of parties. Whether the parties are located in close proximity to each other or thousands of miles apart, conference calls facilitate the flow of information. Conference calls are not limited to the exchange of voice data but may include different forms of multimedia content to provide more advanced exchange of information. Examples of multimedia content are video clips, audio clips, slideshows, advertisements, or other types of content that might include audio portions, video portions, graphical or text portions, combinations of audio, video, graphics or text, and/or other types of media. Multimedia conference calls may be led by a moderator who controls the content that is provided to the participants.

### SUMMARY

In one embodiment, a multimedia conference system is provided that includes a conference server, a file server, an organizer system, and one or more participant systems. The conference server is configured to promote participants conferencing. The file server is configured to maintain conference related multimedia content. The organizer system is used by an organizer to arrange a conference using the conference server. The organizer uses the organizer system to promote storing conference related multimedia content to the file server. The one or more participant systems are used by participants to join the conference and retrieve separate instances of the conference related multimedia content.

In another embodiment, a method for multimedia conferencing is provided. The method includes placing multimedia content on a file server, and engaging in a conference supported by a conference server. The method includes retrieving a list of multimedia content related to the conference, and responsive to selecting the multimedia content from the list during the conference, retrieving a separate instance of the multimedia content from the file server.

In another embodiment, a system for multimedia conferencing is provided. The system includes a conference server and a file server. The conference server is configured to promote participants conferencing. The file server is configured to maintain conference related multimedia content. An organizer organizes a conference using the conference server. The organizer promotes storing conference related multimedia content to the file server. One or more participants join the conference and retrieve separate instances of the conference related multimedia content from the file server.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an illustration of an embodiment of a system for a multimedia conference call.

FIG. 2 is an illustration of one embodiment of a message flow for pre-distribution of content for a multimedia conference call.

FIG. 3 is an illustration of one embodiment of an interface for an organizer of a multimedia conference call.

FIG. 4 is an illustration of one embodiment of a message flow of a dial out method for a multimedia conference call.

FIG. 5 is an illustration of one embodiment of a message flow of a dial in method for a multimedia conference call.

FIG. 6 is an illustration of one embodiment of an interface for a participant of a multimedia conference call.

FIG. 7 illustrates an exemplary general purpose computer system suitable for implementing the several embodiments of the disclosure.

FIG. 8 illustrates a wireless communications system including a handset.

FIG. 9 shows a block diagram of the handset including a digital signal processor and a memory.

FIG. 10 illustrates a software environment implemented by the digital signal processor.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Traditionally, conference calls were carried out mainly through a voice path among several parties. As technology increased over time, various forms of multimedia were added and are still being added to conference calls. Since implementing various forms of multimedia such as pictures, videos, data, and voice requires more protocols, standards, and functions, there is also a requirement for more bandwidth to accommodate these various technical aspects. In addition to more bandwidth needed, there may be a significant increase in costs, difficulties in communication with other parties' systems, and a lack of quality of service (QoS). Real-time data sharing, or streaming, may also encourage difficulties such as increasing costs and inefficient sharing of the multimedia in conference calls. Real-time streaming allows parties to view data being shared between parties, simultaneously, which instigates more bandwidth usage and more chances of technical difficulties.

In embodiments of the present disclosure, prior to a multimedia conference call being placed, an organizer may want to upload resources to be made available during the multimedia conference call. The resources may contain various forms of content, such as video files, documents, and slides. These resources are uploaded to a file server and are accessible to the future participants of the multimedia conference call. The organizer uploads the resources by accessing a conference setup application on a conference server. The setup application may cause a conference management page, such as a web page, to appear on a computing device used by the organizer. The organizer may use the conference management page to set the parameters of the multimedia conference call. For example, the organizer might use the conference management page to select the resources that are to be uploaded, to identify the future participants in the conference call, and to specify the time of the multimedia conference call. The file server saves the resources and the conference server saves links to the resources and other conference call-related parameters in a multimedia conference profile. The links might be uniform resource locators (URLs), file paths in a file directory, and/or other identifiers that allow conference participants to retrieve the resources. As used herein, the term URL will refer to any such link.

Since multimedia content can consume a large amount of bandwidth, the procedure of uploading resources to a file server prior to the initiation of a multimedia conference call may facilitate the flow of communications among the participants in the multimedia conference call. Although the multimedia conference call set-up is carried out in a traditional fashion, there may be a separate data path for the resource content. The pre-distributed resources are stored separately by the organizer and downloaded separately by the participants which allows for ease of resource content sharing. This may result in the elimination of real-time streaming. Pre-distributing resource content by an organizer and participants retrieving the pre-distributed resource content may lower bandwidth and decrease the amount of technical difficulties typically associated with conferencing.

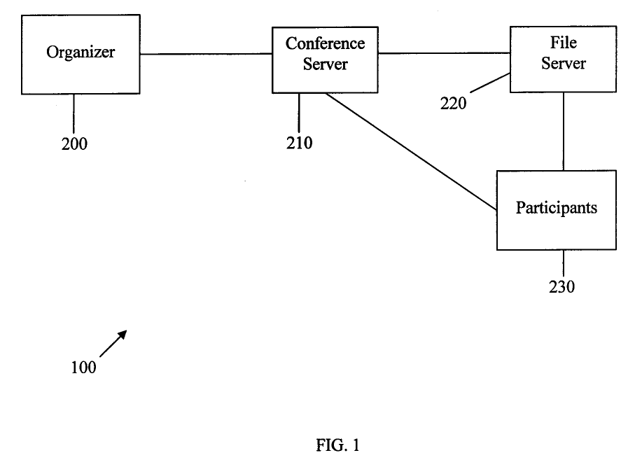

FIG. 1 displays an illustration of an embodiment of a system 100 for organizing and participating in a multimedia (MM) conference call. The system 100 comprises an organizer 200, a plurality of participants 230, a conference server 210, and a file server 220. It should be understood that although only a single file server 220, participants 230, and conference server 210 are shown, there may be a plurality of any of these components.

The organizer 200 may organize an MM conference call for the plurality of participants 230. The participants 230 may participate in the MM conference call the organizer 200 organizes. The organizer 200 may or may not be one of the participants 230 in the MM conference call. When the MM conference call activates, the participants 230 may follow a set of instructions, e.g. select specific slides, provided by one of the participants 230 who is acting as a moderator for the MM conference call. The moderator is not necessarily the organizer 200 who organized the MM conference call.

The organizer 200 and the participants 230 may use any type of device for communicating and/or accessing the conference server 210 and/or any of the other components described herein. Examples of suitable devices for the organizer 200 and the participants 230 include personal digital assistants (PDAs), portable computers, such as laptop, notebook, and tablet computers, cellular telephones, and other mobile communication or computing systems. Other examples of suitable devices include other types of computers, such as desktop, workstation, and kiosk computers using a wireless or landline network connection.

The conference server 210 may be a server, or a computer system, that comprises one or a combination of other servers, protocols, and functions. For example, the conference server 210 may be a web server, an application server, a media server, a database server, and/or a communications server. The conference server 210 may communicate with and provide services to any of the components described herein. Prior to an MM conference call, the organizer 200 may use the conference server 210 to upload files that the participants 230 may view when the MM conference call is in session. Examples of these files will be discussed below. The conference server 210 may also contain a specific application providing the conference management page and allowing input from the organizer 200.

The file server 220 may be a server that comprises one or a combination of other servers, protocols, and functions. In addition, the file server 220 may be a web server, an application server, a media server, a database server, and/or a communications server. The file server 220 may contain files that the organizer 200 uploads prior to an MM conference call. In one embodiment, the organizer 200 may upload files to the file server 220 using a URL, or file path, or directory on the desktop of their device. In another embodiment, the files may already be stored on the file server 220 and the organizer 200 might simply designate which of the files are to be made available for the MM conference call. The organizer 200 may notify the conference server 210 to assign specific files, for the participants to access, to the MM conference call through a conference management page. The conference management page will be discussed in more detail below. The file server 220 may contain any MM files, related protocols, and related functions to provide the MM files that the organizer 200 uploads. Examples of MM files include, but are not limited to, slideshow presentations, white board images, pictures, videos, and text documents.

The participants 230 might request resources directly from the file server 220 or might send a request to the conference server 210. Upon receipt of the request, the conference server 210 may pull the resources from the file server 220 and send the resources to the participants 230. In an embodiment, the participants 230 may pull resources directly from the file server 220. If the participants 230 and the organizer 200 are located in close proximity with each other and access the same file server(s), then there may be no need for the conference server 210 to act as an intermediary and fetch files from the file server 220 for the participants 230. In another embodiment, the participants 230 may have no connection or communication with the file server 220 at all and will require the conference server 210 to act as an intermediary and fetch files for the participants 230. In one embodiment, the functionality of the file server 220 and the conference server 210 might be provided on a single server or distributed to three or more servers.

The components in the system 100 might communicate with or to each other using some type of network. There may be a network communicating between the participants 230 and the file server 220 and the participants 230 and the conference server 210. There may also be a network communicating between the file server 220 and the conference server 210. In addition, there may be a network communicating between the conference server 210 and the organizer 200. Examples of networks include a packet switched network (PSN), an intranet, the Internet, a local area network (LAN), a public switched telephone network (PSTN), or any other network known to persons of ordinary skill in the art. Persons of ordinary skill in the art may be aware of other types of networks and components through which the components in the system 100 might communicate.

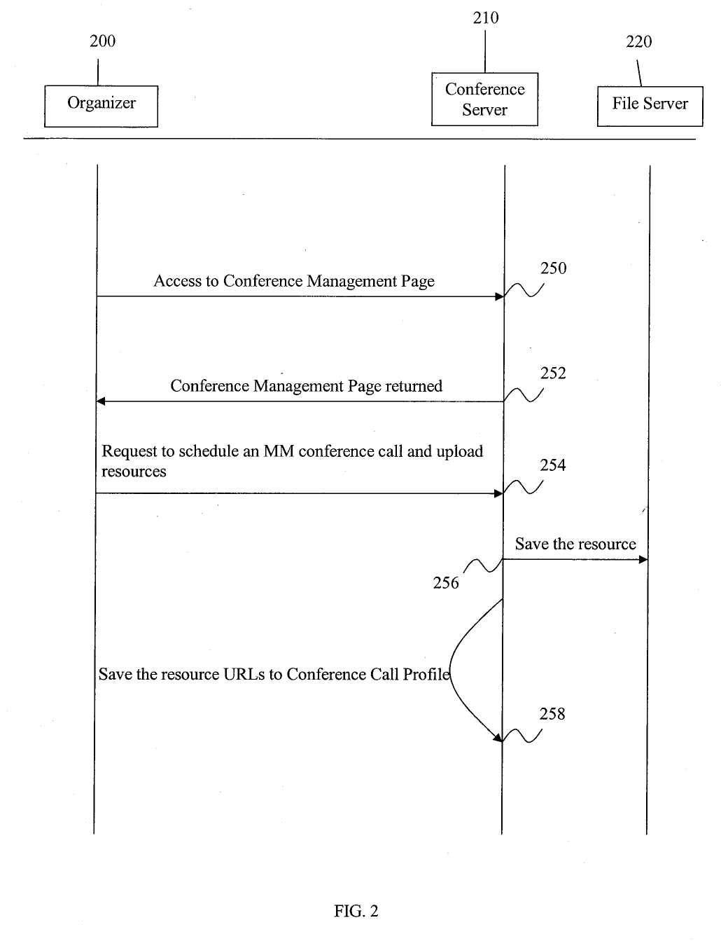

FIG. 2 displays an illustration of a message flow for pre-distribution of content for a multimedia conference call. Prior to an MM conference call occurring, the organizer 200 may upload various types of content, or resources, for the MM conference call. The content is then available for download by participants during the MM conference call. At event 250, the organizer 200 accesses the conference server 210 to request access to the conference management page. At event 252, the conference management page is returned. At event 254, the organizer 200 uses the conference management page to schedule the MM conference call and upload the resources. At event 256, the conference server 210 saves the resources to the file server 220. At event 258, the conference server 210 internally saves the URLs of the resources in order for the resources to be accessible later by the participants 230.

For example, the organizer 200 may want to upload a slideshow presentation to the file server 220. The organizer 200 would communicate with the conference server 210 to launch a setup application that allows access to the conference management page. The conference management page may be an interface displaying an option to schedule an MM conference call. The conference management page may also include a selection of various types of resources to upload. An embodiment of the conference management page will be discussed below. The conference server 210 returns the conference management page to the organizer 200 to view. Via the conference management page, the organizer 200 requests to schedule an MM conference call and selects the slides to be uploaded. The request is sent to the conference server 210. The conference server 210 then informs the file server 220 to save the resources, such as the slide show files.

The conference server 210 saves the URLs of the slide show to an MM conference call profile. In an embodiment, the MM conference call profile may also contain information relating to the time of the MM conference call, the number of participants 230 of the MM conference call, a conference identifier (id), and other conference call-related information. The conference id typically contains numbers and/or letters corresponding to a specific session of a MM conference call.

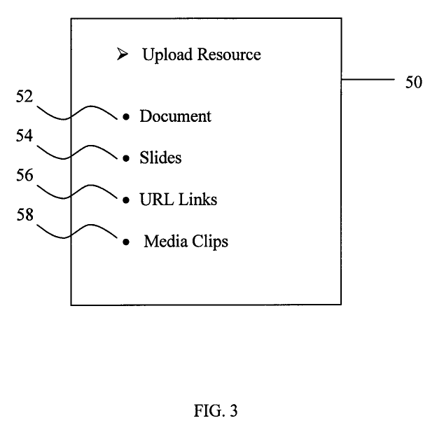

As mentioned previously, when the organizer 200 receives the conference management page, the organizer 200 may choose information relating to the MM conference call, such as the identities of the participants 230. The conference management page may also display a menu item to upload resources. FIG. 3 illustrates one embodiment of a portion 50 of the conference management page for uploading resources. The conference management page may display a menu item to upload resources and various other submenu items such as Document 52, Slides 54, URL Links 56, and Media Clips 58. The submenu item Document 52 may contain a field to select various documents. The submenu item Slides 54 may contain a field to select slides, which may be the various slides in a slide show presentation. The submenu item URL Links 56 may contain a field to select various URL links. For example, the URL link may be a link to a webpage containing an important article related to the MM conference call. The submenu item Media Clips 58 may contain a field to select various media clips. For example, a media clip may be a video of an engineer's presentation related to the subject of the MM conference call.

There may be two methods for initializing a MM conference call. In a dial-out method, the conference server 210 retrieves the resource URLs relevant to the MM conference call before dialing out to the participants 230. Then the conference server 210 sends an invitation to a plurality of participants 230 requesting the participants 230 to join the MM conference call. In a dial-in method, the participants 230 may dial in to the conference server 210 and send a request to join the MM conference call. The conference server 210 then retrieves the resource URLs relevant to the conference call and sends a response to the dial-in request to the participants 230.

Regardless of whether the MM conference call is initiated by the dial-out method or the dial-in method, once the participants 230 accept the invitations or receive the responses, the voice portion of the MM conference call can proceed according to well known conference calling protocols and procedures. At any point during the session of the MM conference call, the participants 230 may request to pull specific resource content, e.g. a slide from a slide show presentation. The conference server 210 is notified of the request, retrieves the resource content from the file server 220, and sends the resource content to the participants 230.

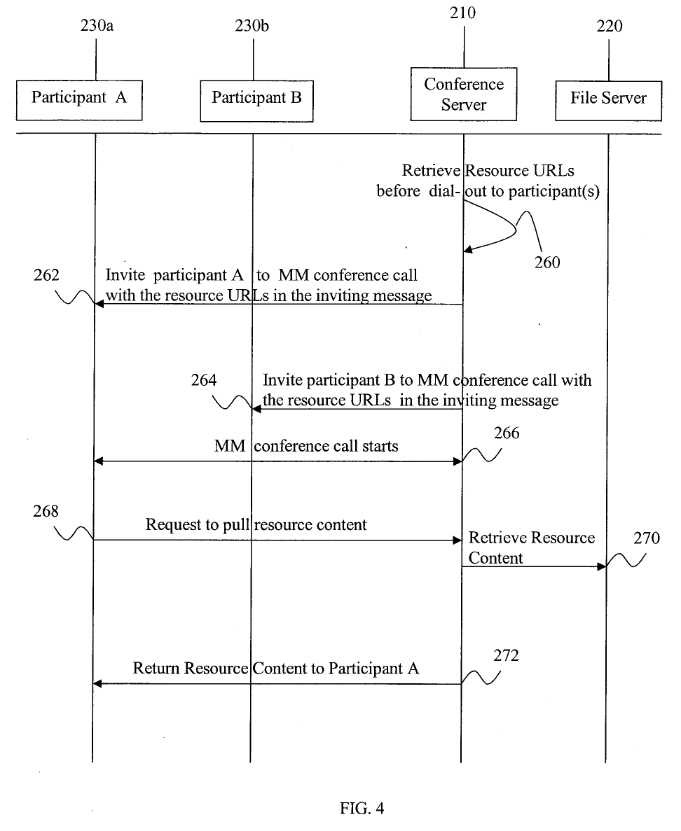

FIG. 4 is an illustration of one embodiment of a message flow of a dial out method for the MM conference call. Prior to the MM conference call initiating, the organizer 200 had set up the parameters for the MM conference call and uploaded the desired resources. In the MM conference call profile, the organizer 200 may have set the MM conference call to initiate at a specific time. When that time arrives, the conference server 210 may be notified and may retrieve the resource URLs, as shown at event 260. At event 262, the conference server 210 sends an invite message containing the resource URLs to the participant A 230a. In an embodiment, the invite message may contain a session initiation protocol (SIP) command, e.g. INVITE.

Once the participant A 230a receives the invite message, the participant A 230a may view the resource URLs. The resource URLs link to the files, e.g. the slide show files that may have been previously uploaded by the organizer 200. At event 264, the conference server 210 also sends an invite message containing the resource URLs to the participant B 230b and the participant B 230b is also able to view the resource URLs. An embodiment of an interface for the participants 230a and 230b to view the resource URLs will be discussed below. In other embodiments, there may be more or less than two participants 230.

At event 266, the MM conference call starts. As informed by a moderator, the participant A 230a or the participant B 230b may request to pull resource content, e.g. a slide. In the embodiment of FIG. 4, the participant A 230a requests content at event 268. The conference server 210 is notified and, at event 270, retrieves the resource content from the file server 220. The conference server 210 returns the resource content to the participant A 230a as shown at event 272. The participant A 230a is able to view the resource content. For example, the participant A 230a may view a slide, designed with text and images, displaying an agenda for the slide show presentation.

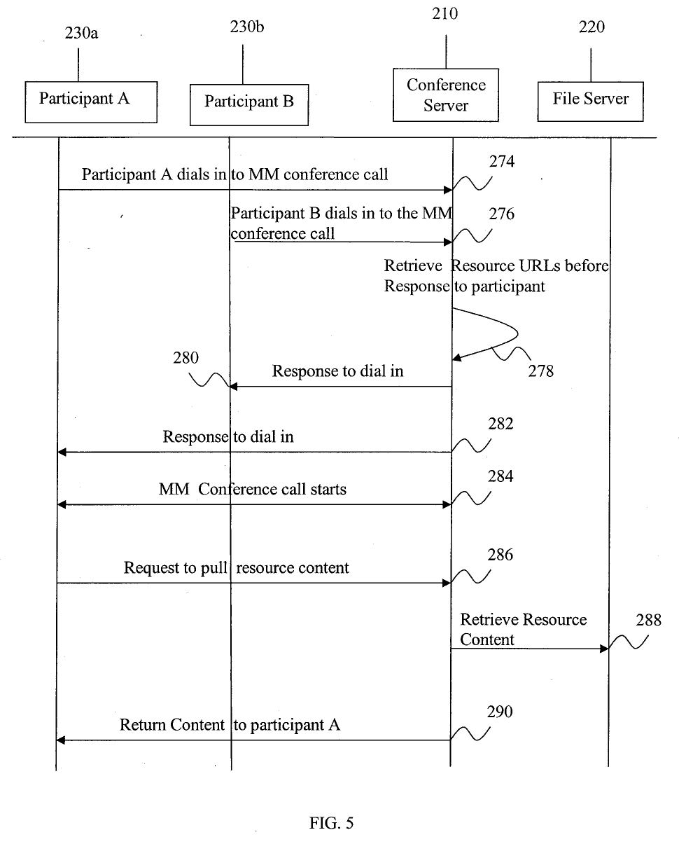

FIG. 5 illustrates one embodiment of a message flow of a dial in method for a MM conference call. At event 274 and event 276, the participants 230a and 230b dial in to a scheduled MM conference call. In an embodiment, the participants 230a and 230b may dial in to the conference server 210 using an invite message that may contain SIP-related commands, such as INVITE. Persons of ordinary skill in the art may be aware of other dial in setup procedures for MM conference calls which may also be used. When the conference server 210 is notified of the two invites, the conference server 210, at event 278, retrieves the resource URLs that are to be sent to the participants 230a and 230b. The conference server 210, at event 280 and event 282, responds to the participants 230a and 230b with a message that contains the resource URLS. When the participants 230a and 230b receive the responses from the conference server 210, the participants 230a and 230b may be able to view the resource URLs each via the participants' 230a and 230b interfaces.

At event 284, the MM conference call starts. At event 286, the participant A 230a requests to view specific resource content during the MM conference call via the interface displaying the resource URLs. For example, the participant A 230a may choose to view a media clip, e.g. an audio file of a discussion among a group of engineers. The request is sent to the conference server 210. At event 288, the conference server 210 retrieves the requested content, such as the audio file, from the file server 220. The conference server 210 then returns the content to the participant A 230a at event 290. Although not shown, the participant B 230b may also request to pull specific resource content at any given time.

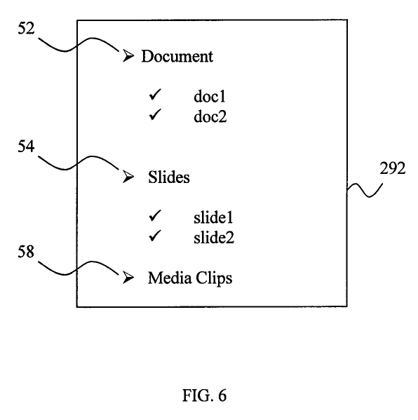

When the resource URLs are sent to the participants 230a and 230b an interface may display the resource URLs as different items and sub-items to choose from. FIG. 6 is an illustration of one embodiment of such an interface 292 for the participants 230a and 230b of the MM conference call The items displayed in FIG. 6 are Document 52, Slides 54, and Media Clips 58. As mentioned previously, the files associated with these items may have been uploaded previously, e.g. by the organizer 200. The Document 52 item contains sub-items such as docd and doc2. Examples of documents may be any array of document types containing texts and/or images, e.g. a document containing the names and pictures of a team working on a specific project. The Slides 54 item contains sub-items such as slide1 and slide2. Slide1 and slide2 may contain descriptive information relating to the slideshow presentation of the MM conference call. In the previous example, when the participant A 230a requested specific resource content to view, the participant A 230a chose the slide. In the interface 292 of FIG.6, the chosen slide may be specifically slide1. Another item displayed on the interface 292 may be a Media Clips 58 item. Although no sub-items are shown for the Media Clips item, in other embodiments there may be sub-items. In addition, the number of items and sub-items may be more or less than the number shown.

The resource content may be stored in the file server 220 for a fixed amount of time, typically designated by the organizer 200, so that access to the resource content may be granted to the participants 230a and 230b at a time when a MM conference call is not in an active session. For example, when the MM conference call terminates, the participant B 230b may decide to pull a specific document. When the participant B 230b accesses the conference server 210, the participant B 230b may view an interface with a conference id field. Once the participant B 230b inputs the conference id corresponding with the MM conference call, the participant B 230b can then start to access the specific content.

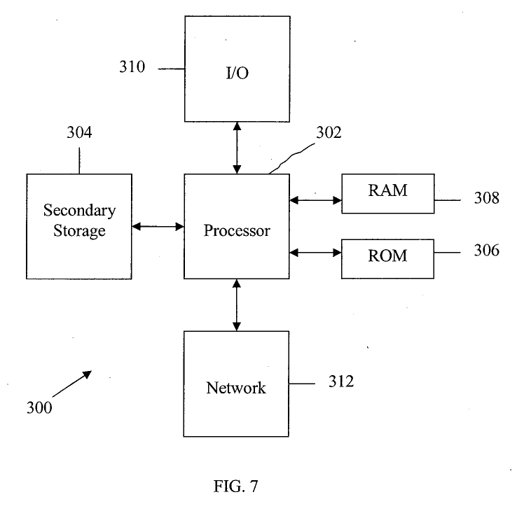

The network components described above may be implemented on any general-purpose network component, such as a computer, network, or node, with sufficient processing power, memory resources, and network throughput capability to handle the necessary workload placed upon it. FIG. 7 illustrates a typical, general-purpose network component suitable for implementing one or more embodiments of a node disclosed herein. The network component 300 includes a processor 302 (which may be referred to as a central processor unit or CPU) that is in communication with memory devices including secondary storage 304, read only memory (ROM) 306, random access memory (RAM) 308, input/output (I/O) 310 devices, and network connectivity devices 312. The processor may be implemented as one or more CPU chips.

The secondary storage 304 is typically comprised of one or more disk drives or tape drives and is used for non-volatile storage of data and as an over-flow data storage device if RAM 308 is not large enough to hold all working data. Secondary storage 304 may be used to store programs that are loaded into RAM 308 when such programs are selected for execution. The ROM 306 is used to store instructions and perhaps data that are read during program execution. ROM 306 is a non-volatile memory device that typically has a small memory capacity relative to the larger memory capacity of secondary storage. The RAM 308 is used to store volatile data and perhaps to store instructions. Access to both ROM 306 and RAM 308 is typically faster than to secondary storage 304.

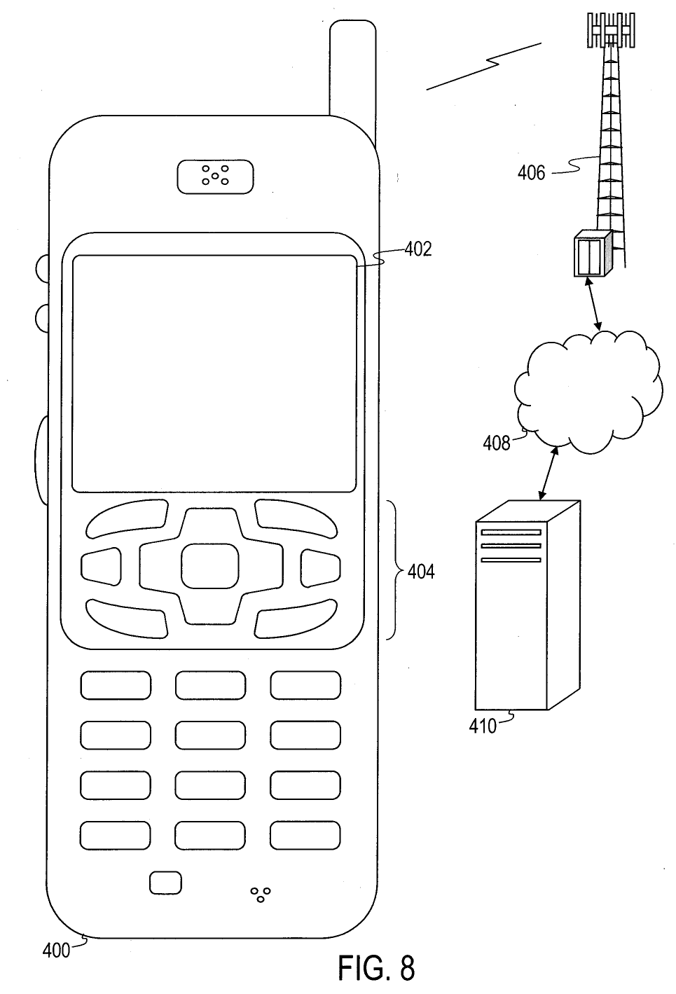

FIG. 8 shows a wireless communications system including a handset 400 that may be operable for implementing aspects of the present disclosure, but the present disclosure should not be limited to these implementations. Though illustrated as a mobile phone, the handset 400 may take various forms including a wireless handset, a pager, a personal digital assistant (PDA), a portable computer, a tablet computer, or a laptop computer. Many suitable handsets combine some or all of these functions. In some embodiments of the present disclosure, the handset 400 is not a general purpose computing device like a portable, laptop or tablet computer, but rather is a special-purpose communications device such as a mobile phone, wireless handset, pager, or PDA.

The handset 400 includes a display 402 and a touch-sensitive surface or keys 404 for input by a user. The handset 400 may present options for the user to select, controls for the user to actuate, and/or cursors or other indicators for the user to direct. The handset 400 may further accept data entry from the user, including numbers to dial or various parameter values for configuring the operation of the handset 400. The handset 400 may further execute one or more software or firmware applications in response to user commands. These applications may configure the handset 400 to perform various customized functions in response to user interaction.

Among the various applications executable by the handset 400 are a web browser, which enables the display 402 to show a web page. The web page is obtained via wireless communications with a cell tower 406, a wireless network access node, or any other wireless communication network or system. The cell tower 406 (or wireless network access node) is coupled to a wired network 408, such as the Internet. Via the wireless link and the wired network, the handset 400 has access to information on various servers, such as a server 410. The server 410 may provide content that may be shown on the display 110.

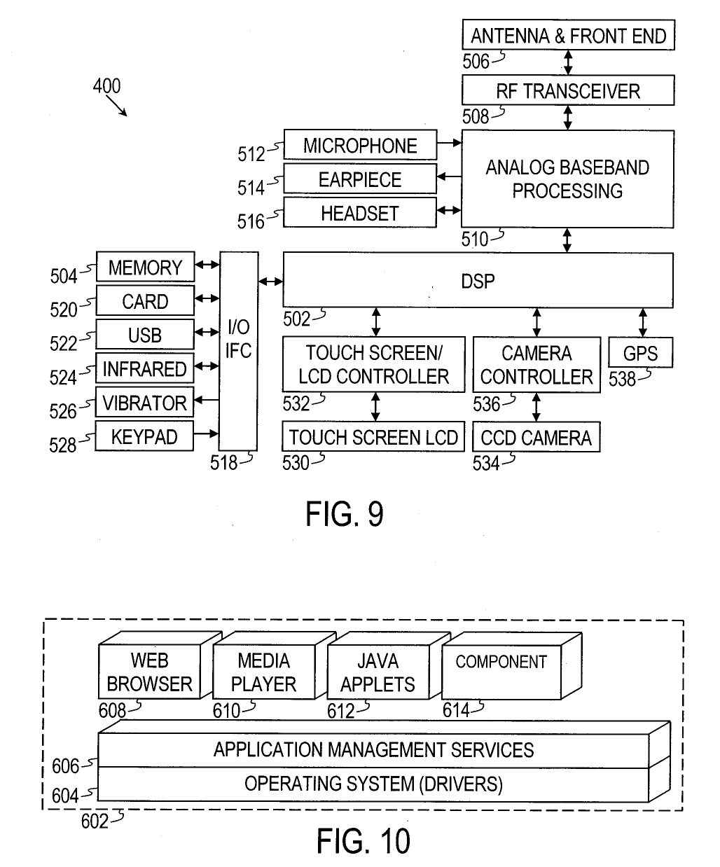

FIG. 9 shows a block diagram of the handset 400. The handset 400 includes a digital signal processor (DSP) 502 and a memory 504. As shown, the handset 400 may further include an antenna and front end unit 506, a radio frequency (RF) transceiver 508, an analog baseband processing unit 510, a microphone 512, an earpiece speaker 514, a headset port 516, an input/output interface 518, a removable memory card 520, a universal serial bus (USB) port 522, an infrared port 524, a vibrator 526, a keypad 528, a touch screen liquid crystal display (LCD) with a touch sensitive surface 530, a touch screen/LCD controller 532, a charge-coupled device (CCD) camera 534, a camera controller 536, and a global positioning system (GPS) sensor 538.

The DSP 502 or some other form of controller or central processing unit operates to control the various components of the handset 400 in accordance with embedded software or firmware stored in memory 504. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The antenna and front end unit 506 may be provided to convert between wireless signals and electrical signals, enabling the handset 400 to send and receive information from a cellular network or some other available wireless communications network. The RF transceiver 508 provides frequency shifting, converting received RF signals to baseband and converting baseband transmit signals to RF. The analog baseband processing unit 510 may provide channel equalization and signal demodulation to extract information from received signals, may modulate information to create transmit signals, and may provide analog filtering for audio signals. To that end, the analog baseband processing unit 510 may have ports for connecting to the built-in microphone 512 and the earpiece speaker 514 that enable the handset 400 to be used as a cell phone. The analog baseband processing unit 510 may further include a port for connecting to a headset or other hands-free microphone and speaker configuration.

The DSP 502 may send and receive digital communications with a wireless network via the analog baseband processing unit 510. In some embodiments, these digital communications may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB interface 522 and the infrared port 524. The USB interface 522 may enable the handset 400 to function as a peripheral device to exchange information with a personal computer or other computer system. The infrared port 524 and other optional ports such as a Bluetooth interface or an IEEE 802.11 compliant wireless interface may enable the handset 400 to communicate wirelessly with other nearby handsets and/or wireless base stations.

The input/output interface 518 may further connect the DSP 502 to the vibrator 526 that, when triggered, causes the handset 400 to vibrate. The vibrator 526 may serve as a mechanism for silently alerting the user to any of various events such as an incoming call, a new text message, and an appointment reminder.

The keypad 528 couples to the DSP 502 via the interface 518 to provide one mechanism for the user to make selections, enter information, and otherwise provide input to the handset 400. Another input mechanism may be the touch screen LCD 530, which may also display text and/or graphics to the user. The touch screen LCD controller 532 couples the DSP 502 to the touch screen LCD 530.

The CCD camera 534 enables the handset 400 to take digital pictures. The DSP 502 communicates with the CCD camera 534 via the camera controller 536. The GPS sensor 538 is coupled to the DSP 502 to decode global positioning system signals, thereby enabling the handset 400 to determine its position. Various other peripherals may also be included to provide additional functions, e.g., radio and television reception.

FIG. 10 illustrates a software environment 602 that may be implemented by the DSP 502. The DSP 502 executes operating system drivers 604 that provide a platform from which the rest of the software operates. The operating system drivers 604 provide drivers for the handset hardware with standardized interfaces that are accessible to application software. The operating system drivers 604 include application management services (“AMS”) 606 that transfer control between applications running on the handset 400. Also shown in FIG. 10 are a web browser application 608, a media player application 610, and Java applets 612. The web browser application 608 configures the handset 400 to operate as a web browser, allowing a user to enter information into forms and select links to retrieve and view web pages. The media player application 610 configures the handset 400 to retrieve and play audio or audiovisual media. The Java applets 612 configure the handset 400 to provide games, utilities, and other functionality. A component 614 might provide functionality related to transmitting and receiving data related to multimedia conference calling.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A multimedia conference system, comprising:
a conference server configured to promote participants conferencing;
a file server configured to maintain conference related multimedia content;
an organizer system used by an organizer to arrange a conference using the conference server, the organizer using the organizer system to promote storing conference related multimedia content to the file server; and
one or more participant systems used by participants to join the conference and retrieve separate instances of the conference related multimedia content.

2. The multimedia conference system of claim 1, wherein the organizer via the conference server identifies the conference related multimedia content.

3. The multimedia conference system of claim 1, wherein the participants receive a listing of the conference related multimedia content.

4. The multimedia conference system of claim 3, wherein the listing includes a GUI (Graphical User Interface) of the conference related multimedia content and wherein the participants select the conference related multimedia content via the GUI prompting transmission and receipt of the separate instance of the conference related multimedia content.

5. The multimedia conference system of claim 1, wherein the conference server promotes notifying the participants regarding the conference, the notification including a listing of the conference details including the conference related multimedia content.

6. The multimedia conference system of claim 1, wherein one or more of the participants initiate contact with the conference via the conference server and obtain a listing of the conference details including identifying the conference related multimedia content.

7. The multimedia conference system of claim 1, wherein the organizer using the organizer system identifies one or more of the participants.

8. A method for multimedia conferencing, comprising:
placing multimedia content on a file server;
engaging in a conference supported by a conference server;
retrieving a list of multimedia content related to the conference; and
responsive to selecting the multimedia content from the list during the conference, retrieving a separate instance of the multimedia content from the file server.

9. The method of claim 8, further comprising identifying a list of conference participants.

10. The method of claim 9, further comprising notifying the list of conference participants regarding the conference.

11. The method of claims 8, wherein the list is a user interface (UI) including a listing of the multimedia content.

12. The method of claims 8, further comprising using a conference identifier to retrieve the multimedia content from the file server after the conference.

13. The method of claims 8, wherein the multimedia content includes at least one of audio content, video content, audio and video content, slides, movies, and pictures.

14. The method of claims 8, further comprising an organizer scheduling the conference via the conference server.

15. The method of claim 8, further comprising:
notifying the participants regarding the conference;
the participants accepting to join the conference; and
the participants receiving the listing to the multimedia content.

16. The method of claim 8, further comprising:
the participants dialing in to join the conference; and
the participants receiving the listing to the multimedia content responsive to dialing in to join the conference.

17. A system for multimedia conferencing, comprising:
a conference server configured to promote participants conferencing; and
a file server configured to maintain conference related multimedia content, and wherein an organizer organizes a conference using the conference server, the organizer promoting storing conference related multimedia content to the file server, and further wherein one or more participants join the conference and retrieve separate instances of the conference related multimedia content from the file server.

18. The system of claim 17, wherein the organizer is one of the participants.

19. The system of claim 17, further comprising a component to list the conference related multimedia content available on the file server.

20. The system of claim 17, wherein the organizer identifies the participants of the conference.
